(19) United States
(12) Patent Application Publication
(10) Pub. No.: US 2021/0079551 A1
(43) Pub. Date: Mar. 18, 2021

(54) METHOD AND DEVICE FOR FILTERING A PLATINUM BATH BY ELECTRODIALYSIS

(71) Applicants: SAFRAN AIRCRAFT ENGINES, Paris (FR); CENTRE NATIONAL DE LA RECHERCHE SCIENTIFIQUE, Paris (FR); UNIVERSITE PAUL SABATIER - TOULOUSE III, Toulouse (FR)

(72) Inventors: Auriane GENGO, Moissy-Cramayel (FR); Sylvain GALIER, Saint Pierre de Lages (FR); Hélène ROUX-DE BALMANN, Roquettes (FR)

(73) Assignees: SAFRAN AIRCRAFT ENGINES, Paris (FR); CENTRE NATIONAL DE LA RECHERCHE SCIENTIFIQUE, Paris (FR); UNIVERSITE PAUL SABATIER - TOULOUSE III, Toulouse (FR)

(21) Appl. No.: 16/613,680

(22) PCT Filed: May 16, 2018
(86) PCT No.: PCT/FR2018/051178

§ 371 Date: Nov. 14, 2019

(30) Foreign Application Priority Data
May 16, 2017 (FR) 1754283

(51) Int. Cl. C25D 21/18; C25D 3/50; B01D 61/46

(52) U.S. Cl. CPC C25D 21/18; C25D 3/50; B01D 2311/10; B01D 2311/18; B01D 61/46

(57) ABSTRACT

Method for filtering a platinum bath by electrodialysis, including consecutive steps of extracting fluid from the platinum bat by an extraction current; filtering the fluid extracted during the extraction step, carried out by electrodialysis in a filtering device having an electrodialysis reactor; supplying the platinum bath with the fluid from the filtering step, by a filtered bath current; all of these steps being carried out in a continuous flow.

### FIELD OF THE INVENTION

The present disclosure relates to the field of platinum baths for the production of platinum-based metallic bond coat on a metal substrate, more particularly a method for filtering platinum bath elements by electrodialysis, as well as a device for filtering the platinum bath.

### STATE OF THE PRIOR ART

Turbomachine turbine blade parts made of superalloy can be coated with a metallic bond coat to protect the material from oxidation/corrosion. Blade parts can also include a ceramic layer that acts as a thermal barrier. The metallic bond coat then allows a better adhesion of the ceramic layer on the blade part. This metallic bond coat is produced in particular by electrolytic deposition of platinum from a platinum bath. A method for manufacturing such a bath, for the production of a platinum-based metallic bond coat, is for example described in patent FR2989694.

Today, the use of platinum baths is relatively well controlled. To form a metallic bond coat, the platinum bath comprises one or more platinum complexes which, under the effect of the electrical current flowing through the bath, settle on the metallic part to form the metallic bond coat.

Thus, over the course of platinum bond coat deposits on metal parts, the platinum complex content in the platinum bath, as well as the pH of the platinum bath, tend to decrease. As a result, the concentration of platinum in complexed form in the bath is not constant over time. The deposition rate and time are therefore also not constant. It is therefore necessary either to replace or regenerate the platinum bath.

In view of the cost of bath compounds, especially platinum, the regeneration of the platinum bath is generally preferred.

Thus, when the total platinum content of the bath reaches a predetermined lower limit, the electrolytic deposition of platinum on the metal parts is stopped and the platinum bath is regenerated.

Typically, this regeneration of the platinum bath is achieved by direct addition of platinum salts to the bath or by intensified reaction. The addition of soda is also necessary to maintain a substantially constant pH of the platinum bath.

Furthermore, in addition to platinum itself, the platinum bath also contains Cl⁻, Na⁺ and NO₃⁻ ions. As platinum bond coats are deposited on metal parts, and thus as the platinum bath regenerates and soda is added, the content of these elements in the platinum bath increases. Above a certain threshold, the presence of these elements in the platinum bath acts as a “pollutant”, which can impair its proper functioning. Indeed, too high a concentration of these elements in the platinum bath can disrupt the platinum deposition process. It is therefore necessary to replace the platinum bath or to limit their concentration in the bath. Given the cost of bath compounds, especially platinum, replacing the platinum bath is not the preferred solution.

There is therefore a need to guarantee the quality of the platinum deposit, without altering the properties of the bath, and thus to extend its lifespan.

### PRESENTATION OF THE INVENTION

The present disclosure relates to a method for filtering a platinum bath by electrodialysis, comprising consecutive steps of:
extracting fluid from the platinum bath by means of an extraction current;
filtering the fluid extracted during the extraction step, carried out by electrodialysis in a filtering device comprising an electrodialysis reactor;
supplying the platinum bath with the fluid from the filtering step to the platinum bath by means of a filtered bath current;
   all of these steps being carried out in a continuous flow.

In the present disclosure, the combination of the platinum bath, the extraction current, the electrodialysis reactor and the filtered bath current forms a circulation loop in which a fluid flows. “Fluid” refers to the liquid flowing through said loop, whether in the platinum bath, in the extraction current before filtering or in the filtered bath current.

In the present disclosure, extraction current refers to the fluid taken from the platinum bath and flowing to the filtering device in a pipe, for example. Filtered bath current refers to the fluid from the filtering device after the filtering step, flowing to the platinum bath in a pipe, for example.

“Continuous flow” means that these steps (extracting, filtering, supplying), constituting a filtering cycle, are carried out successively so that the fluid (extraction current, filtered bath current) flows continuously, without interruption, in particular when it passes through the filtering device during the filtering step.

It is therefore understood that the filtering method can be carried out when a platinum bond coat deposition process is in progress or not.

The filtering method can also be carried out discontinuously. Therefore, for example, the filtering method can be interrupted when no platinum bond coat deposition process is in progress, i.e. depending on the filtering needs of the platinum bath, the filtering method can be stopped, or the filtering method can be interrupted when the platinum bond coat deposition process is in progress. It is understood that the filtering method can be carried out independently of the platinum bond coat deposition process.

This method is possible because the filtering step, which allows the filtering of the platinum bath, is carried out in a specific device, and more precisely in an electrodialysis reactor which is a separate element from and external to said platinum bath. This ensures that production, i.e. the platinum bond coat deposition process, is not interrupted to filter the platinum bath. This makes it possible to maintain the concentration of these elements at a substantially constant value, thus guaranteeing the quality of the platinum deposit, without altering the properties of the bath, and thus extending its lifespan.

In some embodiments, the filtering device also includes a filtering current and an electrode current, the fluid extracted from the platinum bath, the filtering current and the electrode current circulating separately in the electrodialysis reactor, the electrodialysis filtering step being carried out in the electrodialysis reactor.

It is thus understood that three currents flow separately in the electrodialysis reactor: the extraction current to be filtered, coming from the platinum bath, the filtering current allowing the recovery of the elements to be filtered, and whose concentration of elements to be filtered increases during the filtering step in the electrodialysis reactor, and the electrode current flowing along electrodes that the electrodialysis reactor contains, and allowing the reaction to the electrodes. “Separately” means that no current can be mixed with one of the other two currents. These currents can be separated by membranes in the electrodialysis reactor, for example. These membranes are anionic and cationic membranes that allow the anions and cations present in the currents flowing through the electrodialysis reactor to pass through respectively. The concentration of elements to be filtered in the platinum bath can thus be reduced without altering the properties of the bath.

In some embodiments, the flow rate of supply of the reactor by the extraction current and of supply of the reactor by the filtering circuit is between 150 litres/hour (L/h) and 250 L/h, preferably between 165 L/h and 225 L/h, more preferably between 180 L/h and 210 L/h.

In some embodiments, the temperature of the extraction current in the electrodialysis reactor is between 40 and 65° C., preferably 64° C.

In some embodiments, the platinum bath contains Cl⁻ ions, the concentration of Cl⁻ ions in the platinum bath being continuously maintained at a value in the range of 0 to 200 g/L.

In some embodiments, the platinum bath contains Na⁺ ions, the concentration of Na⁺ ions in the platinum bath being continuously maintained at a value in the range of 0 g/L to 200 g/L.

In some embodiments, the platinum bath contains NO₃⁻ ions, the concentration of NO₃⁻ ions in the platinum bath being maintained continuously at a value of 0 g/L.

In the present disclosure, the elements to be filtered in the platinum bath may include Cl⁻ ions ions, Na⁺ ions and NO₃⁻ ions. The method maintains the concentration of the platinum bath in the elements to be filtered in these value ranges. The latter are low enough not to interfere with the proper functioning of the platinum bath and particularly with the process of depositing platinum bond coats on metal parts. However, the NO₃⁻ concentration never reaches values that could affect the quality of platinum deposition.

In some embodiments, the pH of the platinum bath is continuously maintained at a value in the range of 6.10 to 6.3, preferably 6.20.

This pH value of the platinum bath optimizes the deposition of the platinum bond coat. It can be maintained at this value by adding soda in the platinum bath for example.

In some embodiments, the filtering step is performed when the concentration of Cl⁻ ions in the platinum bath is greater than or equal to a first predetermined threshold value, and the concentration of Na⁺ ions in the platinum bath is greater than or equal to a second predetermined threshold value.

The predetermined value of the Cl⁻ ion concentration in the platinum bath can be for example 11 g/L, or the predetermined value of the Na⁺ ion concentration in the platinum bath can be for example 32 g/L. The depollution method, i.e. the circulation of the different currents in the electrodialysis reactor, can thus be implemented when at least one of these predetermined values is reached.

In some embodiments, the filtering step is carried out when the pH of the platinum bath increases by a predetermined value.

The predetermined value can be equal to 0.10. Indeed, due to the repetition of platinum bond coat deposits, the pH of the platinum bath tends to decrease. To maintain this pH at a fairly constant value, for example 6.20, the addition of soda, resulting in an increase in Na⁺ ion concentration, is necessary. The filtering step can therefore be implemented when the pH of the platinum bath increases by, for example, 0.10, from 6.10 to 6.20 in the platinum bath. This detection criterion, which makes it possible to implement the filtering method when the pH of the platinum bath increases by a predetermined value, makes it possible to avoid an analysis of the concentrations of the various ions in the platinum bath, and thus to simplify the filtering method.

In some embodiments, the filtering step is implemented when at least one regeneration of the platinum bath has been carried out.

Regeneration of the platinum bath means the process of maintaining the platinum concentration in complexed form in the platinum bath at a substantially constant value. Regeneration can be carried out by adding platinum salt directly into the platinum bath, or by using an intensified reactor for example. These regenerations of the platinum bath lead to an increase in the concentration of Cl⁻ ions. The implementation of the filtering step, after at least one regeneration of the platinum bath has been carried out, therefore reduces the concentration of Cl⁻ ions in the platinum bath.

In some embodiments, the electrode current has a Na₂SO₄ concentration between 9.0 g/L and 11.0 g/L, preferably between 9.5 g/L and 10.5 g/L, more preferably 10.0 g/L.

In some embodiments, the filtering current is water, the concentration of which in Cl⁻ and Na⁺ ions from the extraction current increases during the filtering step in the electrodialysis reactor.

The present disclosure also relates to a device for filtering a platinum bath by electrodialysis, comprising a device for filtering a platinum bath by electrodialysis, comprising:
a platinum bath;
a filtering bath and an electrode bath;
an electrodialysis reactor supplied by an extraction current from the platinum bath, by a filtering current from the filtering bath and by an electrode current from the electrode bath;
a filtered bath current from the reactor, which supplies the platinum bath.

The filtering bath contains a fluid, which can be water, circulating to the electrodialysis reactor through the filtering current. The electrode bath contains a fluid that allows the reaction to the electrodes in the electrodialysis reactor. This fluid may contain Na₂SO₄ and flows to the electrodialysis reactor through the electrode current.

### BRIEF DESCRIPTION OF THE DRAWINGS

The invention and its advantages will be better understood by reading the detailed description below of different embodiments of the invention, which are given as non-limiting examples. This description refers to the appended pages of figures, wherein:

FIG. 1 shows a block diagram of a platinum bath filtering system according to the present disclosure;

FIG. 2 shows a detailed schematic diagram of the electrodialysis reactor of FIG. 1.

### DETAILED DESCRIPTION OF EXEMPLARY EMBODIMENTS

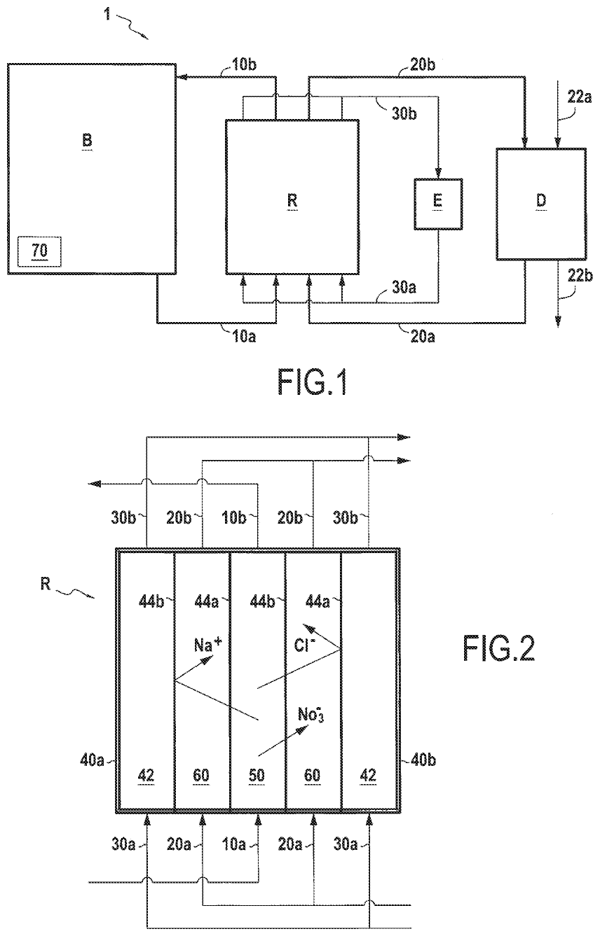

FIG. 1 is a block diagram of a platinum bath filtering device 1 according to the present disclosure. The device 1 comprises a platinum bath B filled at least partially with a fluid comprising one or more platinum complexes to form a metallic bond coat. Under the influence of the electrical current flowing through the bath, the platinum complexes are deposited on the metal part, for example a turbomachine blade part, to form the metallic bond coat.

For example, to produce one litre of platinum bath B at 8 g/litre of platinum, proceed as follows:
preparation of a solution B′: in 300 mL of distilled water (<500 Ω) at 30° C., put 44.0 g of diammonium hydrogen phosphate of chemical formula (NH₄)₂HPO₄ (0.33 mol) and 75.0 g of ammonium dihydrogen phosphate of chemical formula NH₄H₂PO₄ (0.65 mol). The molar ratio between the amount of ammonium dihydrogen phosphate and the amount of diammonium hydrogen phosphate is 2. Once the salts are dissolved, cover the solution and heat to 50° C. for 4.5 hours.
Preparation of solution A′: in 300 mL of distilled water at 45° C., add 5 g of sodium hydroxide of chemical formula NaOH (0.080 mol) and 18.3 g of platinum diammonium hexachloroplatinate salt of formula (NH₄)₂PtCl₆ (0.040 mol). The molar ratio between the amount of soda and the amount of diammonium hexachloroplatinate salt is 2. Dissolve the platinum salts in solution A′;
Once solution B′ is ready and hot, solution A is prepared and added to solution B′ previously heated to 60° C.
Finally, the mixture A′+B′ (whose pH is first adjusted to 6.3 by adding a basic solution such as, for example, soda, potash, sodium triphosphate) is heated to 85° C. for 3 hours. All solutions are covered during the heating steps.
More generally, with this solution B′ comprising diammonium hydrogen phosphate of chemical formula (NH₄)₂HPO₄ and ammonium dihydrogen phosphate of chemical formula NH₄H₂PO₄, the pH of the mixture of solutions A′+B′ is fixed between 6 and 10 and preferably between 6 and 7.

The device 1 also includes an extraction current 10a flowing through a first pipe, a filtering current 20a flowing through a second pipe, and an electrodialysis reactor R. The platinum bath B and the electrodialysis reactor R are connected to each other by the extraction current 10a. The extraction current 10a takes part of the platinum B bath to be filtered and supplies it to the electrodialysis reactor R. A filtered bath current 10b flows through a third pipe and connects the electrodialysis reactor R and the platinum B bath. The filtered fluid, from the electrodialysis reactor R, is then conveyed to the platinum bath B by means of the filtered bath current 10b.

The combination of the platinum bath B, the extraction current 10a, the electrodialysis reactor R and the filtered bath current 10b forms a circulation loop of the platinum bath, changing from a “bath to be filtered” state, in the extraction current 10a, to a “filtered bath” state, in the filtered bath current 10b.

In addition, the platinum bath B may include concentration measuring means 70 to continuously measure the concentration of elements to be filtered in the platinum bath B. The elements to be filtered can be Cl⁻, Na⁺ and NO₃⁻ ions.

A filtering bath D is connected to the electrodialysis reactor R by the filtering solution current 20a. The filtering bath D contains a fluid that can be, for example, water from the public network. The filtering current 20a takes part of the fluid contained in the filtering bath D and conveys it to the electrodialysis reactor R and then, after passing through the electrodialysis reactor, the fluid returns to the filtering bath D by means of a filtering return current 20b.

An electrode bath E is connected to the electrodialysis reactor R by the electrode current 30a. The electrode bath E contains a fluid that can have a Na₂SO₄ concentration between 9 g/L and 11 g/L, preferably between 9.5 g/L and 10.5 g/L, more preferably 10.0 g/L. The electrode current 30a takes part of the fluid contained in the electrode bath E and conveys it to the electrodialysis reactor R and then, after passing through the electrodialysis reactor R, the fluid returns to the electrode bath E by means of an electrode return current 30b.

The three fluids contained in the platinum B bath, the filtering bath D and the electrode bath E respectively circulate separately in the electrodialysis reactor R. To do this, the reactor R has several compartments separated by cationic membranes 44a and anionic membranes 44b parallel to each other, between which the different fluids circulate, without the latter being able to mix with each other. More specifically, as shown schematically in FIG. 2, the reactor R has at least a first compartment 50 in which the extraction current flows, at least a second compartment 60 in which the filtering current 20a flows, and two compartments 42 on either side of compartments 50 and 60, in which the electrode current 30a flows. The reactor R also has two electrodes: a cathode 40a and an anode 40b, arranged on either side of the reactor, along which the electrode current 30a flows. The electrodes, as well as the electrode current 30a, allow the reaction to the electrodes, so that, as they pass through the first and second compartments 50, 60 respectively, the Cl⁻, Na⁺ and NO₃⁻ ions contained in the extraction current 10a migrate through the anionic membranes 44b and cationic membranes 44a into the filtering current 20a. More precisely, the Cl⁻ ions contained in the extraction current 10a, cross the anionic membrane 44b to migrate into the filtering current 20a, and are then retained in said filtering current 20a by being blocked by the cationic membrane 44a. Similarly, the Na⁺ ions contained in the extraction current 10a, pass through the cationic membrane 44a to migrate into the filtering current 20a, and are then retained in said filtering current 20a by being blocked by the anionic membrane 44b.

The filtering bath D can also comprise a water supply current 22a, supplying the filtering bath D, and a water extraction current 22b, extracting part of the water contained in the filtering bath D. Indeed, during the filtering steps in the electrodialysis reactor R, the water from the filtering bath D is charged with elements to be filtered, in particular Cl⁻, Na⁺ and NO₃⁻ ions from the filtering bath. As the water gradually loses its ability to concentrate in these elements to be filtered, the filtering process loses its efficiency over time. The water supply current 22a and the water extraction current 22b therefore allow the content of the filtering bath D to be continuously renewed. “Continuous” means that this renewal can be carried out whether or not a filtering process in the reactor R is in progress. Alternatively to the water supply current 22a and the water extraction current 22b, the content of the filtering bath D can be changed when the Cl⁻ concentration reaches a value between 8.0 and 10.0 g/L.

The filtering method can be implemented when the concentration measuring means 70 detect that either Cl⁻ or Na⁺ concentration exceeds a predetermined threshold value. The predetermined threshold value of the Cl⁻ ion concentration in the platinum bath can be for example 11 g/L, and the predetermined value of the Na⁺ ion concentration in the platinum bath can be for example 32 g/L.

The filtering method can also be used when pH measuring means (not shown) detects that the pH of the platinum bath is increasing by a predetermined value. Indeed, during platinum bond coat deposition processes, the pH of the platinum bath tends to decrease. To maintain this pH at a target value, for example 6.20, it is necessary to add soda in the bath. This addition causes the increase in Na⁺ ions in the bath. The predetermined value for increasing the pH of the platinum bath is a value to return to the target value. This predetermined value can be, for example, 0.10, allowing to go from a pH of 6.10 to 6.20. Thus, the detection of a 0.10 pH increase characterizes an addition of soda and therefore an increase in the concentration of Na⁺ ions in the bath, and thus the need to implement the filtering method.

The filtering method is also used when at least one regeneration of the platinum bath has been carried out. Indeed, the regeneration process generates an increase in Cl⁻ ions in the platinum bath. Thus, the filtering method is implemented when the pH of the platinum bath increases by the predetermined value, and a regeneration process of the platinum bath has been carried out.

The different currents (extraction current, filtering current and electrode current) are then circulated by means of pumps (not shown). The elements to be filtered (Cl⁻ and Na⁺ ions) contained in the extraction current 10a are then partially transferred to the filtering current 20b, by virtue of the electric current passing through the electrodialysis reactor R. The filtered bath current 10b, which has a lower concentration of elements to be filtered than the extraction current, is then recharged into the platinum bath B. This filtering operation can be performed even when a platinum bond coat deposition process is in progress.

Although the present invention has been described by reference to specific exemplary embodiments, it is obvious that modifications and changes can be made to these examples without going beyond the general scope of the invention as defined by the claims. In particular, individual features of the different embodiments illustrated/mentioned may be combined in additional embodiments. Therefore, the description and drawings should be considered in an illustrative rather than restrictive sense.

It is also obvious that all the features described with reference to a method can be transposed, alone or in combination, to a device, and conversely, all the features described with reference to a device can be transposed, alone or in combination, to a method.

1. Method for filtering a platinum bath by electrodialysis, the platinum bath containing Cl⁻ ions and Na⁺ ions, the method comprising consecutive steps of:
extracting fluid from the platinum bath by means of an extraction current;
filtering the fluid extracted during the extraction step, carried out by electrodialysis in a filtering device comprising an electrodialysis reactor;
supplying the platinum bath with the fluid from the filtering step, by means of a filtered bath current;
all of these steps being carried out in a continuous flow, and the filtering step being carried out when the concentration of Cl⁻ ions in the platinum bath is greater than or equal to a first predetermined threshold value, or the concentration of Na⁺ ions in the platinum bath is greater than or equal to a second predetermined threshold value.

2. Method according to claim 1, wherein the filtering device further comprises a filtering current and an electrode current, the fluid extracted from the platinum bath, the filtering current and the electrode current flowing separately in the electrodialysis reactor, the electrodialysis filtering step being performed in the electrodialysis reactor.

3. Method according to claim 1, wherein the temperature of the extraction current in the electrodialysis reactor is between 40 and 65° C.

4. Method according to claim 1, wherein the concentration of Cl⁻ ions in the platinum bath is continuously maintained at a value within a range of 0 to 200 g/L.

5. Method according to claim 1, wherein the concentration of Na⁺ ions in the platinum bath is continuously maintained at a value within a range of 0 to 200 g/L.

6. Method according to claim 1, wherein the pH of the platinum bath is continuously maintained at a value in the range of 6.10 to 6.30.

7. Method according claim 1, wherein the filtering step is carried out when the pH of the platinum bath increases by a predetermined value.

8. Method according to claim 1, wherein the filtering step is carried out when at least one regeneration of the platinum bath has been carried out.

9. Device for filtering a platinum bath by electrodialysis, comprising:
a platinum bath comprising Cl⁻ ions and Na⁺ ions and concentration measuring means for continuously measuring the concentration of Cl⁻ ions and Na⁺ ions, the device for filtering being configured to be implemented when the concentration measuring means detect that either Cl⁻ or Na⁺ concentration exceeds a predetermined threshold value;
a filtering bath and an electrode bath;
an electrodialysis reactor fed by an extraction current from the platinum bath, by a filtering current from the filtering bath and by an electrode current from the electrode bath;
a filtered bath current from the reactor, which supplies the platinum bath.

10. Method according to claim 1, wherein the temperature of the extraction current in the electrodialysis reactor is 64° C.

11. Method according to claim 1, wherein the pH of the platinum bath is continuously maintained at a value of 6.20.
